(19) United States
(12) Patent Application Publication
(10) Pub. No.: US 2017/0249689 A1
(43) Pub. Date: Aug. 31, 2017

(54) AUTOMATED PROCESSING OF ONLINE SOCIAL NETWORKING DATA FOR INTEGRATION WITH AN INVENTORY MANAGEMENT SYSTEM

(71) Applicant: PAYPAL, INC, San Jose, CA (US)

(72) Inventors: Megan Marie O'Neill, San Jose, CA (US); Shilpa Dhar, San Jose, CA (US); Marc Denis Kocher, San Jose, CA (US); Bill Scott, San Jose, CA (US); Dereck Quock, San Jose, CA (US); Sumit Savla, Milpitas, CA (US); Greg Crescimanno, San Jose, CA (US); Erik Toth, San Jose, CA (US)

(21) Appl. No.: 15/442,365

(22) Filed: Feb. 24, 2017

Related U.S. Application Data
(60) Provisional application No. 62/300,569, filed on Feb. 26, 2016.

(51) Int. Cl. G06Q 30/06; G06Q 10/08; G06Q 50/00

(52) U.S. Cl. CPC G06Q 30/0635; G06Q 50/01; G06Q 10/087

(57) ABSTRACT

There is provided a system and method of automated processing of online social networking data for integration with an inventory management system. A merchant or other selling entity may post data to a social networking platform, where the posted data includes an item for sale. A transaction processor may process the post data to determine the item for sale with a backend merchant inventory management system or other sales platform. The transaction processor may then poll comments to the posted data to determine whether any users are requesting to purchase the item. If the transaction processor identifies a purchase request, the transaction processor may interface with the merchant's sales platform to determine availability, cost, and other parameters, and may generate an invoice for the item. The invoice may be communicated to the user, and the transaction processor may update the merchant with results from processing the invoice.

### TECHNICAL FIELD

This application claims priority to U.S. Provisional Patent Application No. 62/300,569 titled “AUTOMATED MERCHANT PURCHASING THROUGH A SOCIAL NETWORKING PLATFORM,” filed on Feb. 26, 2016, which is hereby incorporated by reference in its entirety

### TECHNICAL FIELD

The present application generally relates to processing integration of backend merchant systems with online social networking platforms and more specifically to processing of social networking posts and interactions to perform merchant processes.

### BACKGROUND

Merchants may provide sales to users through physical merchant retail locations, as well as online marketplaces including specific merchant websites, multiple merchant sales portals, and other types of online resources that may be accessed through a web browser, dedicated application, and/or messaging platform (e.g., SMS, FACEBOOK® messaging, etc.). However, the merchant may be required to advertise for items in order to raise brand and/or item awareness, which may be costly and time consuming. Traditionally, the merchant may pay for advertisements to be aired, posted, or otherwise communicated to users, including through online messaging platforms. The merchant may also utilize social networking platforms to raise awareness for the merchant and display the merchant's goods, including media sharing platforms (e.g., image/video posting and/or sharing platforms).

Thus, users may view items available for sale on an online social networking platform. However, in order to purchase the item, the merchant may provide a selectable link for the item with the platform or may require the user to enter item information into another marketplace or search engine. Both processes are time consuming and may deter users from making purchases. Moreover, if the merchant does not have an online sales platform, users may be required to visit a physical merchant location, which may cause undue friction in purchasing or may cause users to forget or forego purchases from the merchant.

### BRIEF DESCRIPTION OF THE DRAWINGS

FIG. 1 is a block diagram of a networked system suitable for implementing the processes described herein, according to an embodiment;

FIG. 2A is an exemplary flowchart to determine purchase requests and generate invoices for users from a social networking post by a seller, according to an embodiment;

FIG. 2B is an exemplary flowchart for providing on-boarding to an integration platform for item sales through social networking posts of a seller, according to an embodiment;

FIG. 3 is a block diagram of a social networking post used to generate an invoice to a user purchasing an item in the social networking post, according to an embodiment;

FIG. 4 is a block diagram of a transaction processor server interacting with a communication device and a merchant device to provide sales and transaction processing through social networking posts, according to an embodiment;

FIG. 5 is an exemplary process flowchart for social commerce payments based on comments to social networking posts, according to an embodiment; and

FIG. 6 is a block diagram of a computer system suitable for implementing one or more components in FIG. 1, according to an embodiment.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

Provided are methods utilized for integration of backend merchant systems with online social networking platforms. Systems suitable for practicing methods of the present disclosure are also provided.

Merchants (e.g., a seller or payment receiver, such as a business, fundraiser, healthcare provider, landlord, etc.) may correspond to any person or entity selling goods and/or services (referred to herein as an “item” or “items”) to other users/entities, such as buyers (e.g., a payer or payment sender, including a customer, donator, patient, renter, or other party). Service providers may use transaction processing entities (e.g., a “transaction processor” or “transaction processors”), which may provide transaction processing and payment services to one or more buyers (e.g., users) for use with sellers (e.g., merchants or other type of selling entity). For example, a transaction processor entity may provide a transaction processing platform to a user to provide payments to a merchant or other seller, for example, through electronic payments processed using the payment platform. Moreover, the transaction processor may offer infrastructure, software, and/or other transaction processing and payment features to the merchant, including account services. For example, the transaction processor or other service provider device may further provide account services and digital wallet services, which may allow the user to store one or more financial instruments of the user for use in transaction processing and provide a digital wallet that may be utilized to perform transaction processing through tokenized payment services.

Users and/or merchants may also utilize other types of service providers involved in online communications, including social networking, media sharing, and/or microblogging types of services that allow users and/or merchants to communicate with other users/merchants, post visual data and comments, and/or provide notifications or updates to other users. Thus, these other types of service providers may include online social networking services, such as FACEBOOK®, INSTAGRAM®, IMGUR®, TWITTER®, SNAPCHAT®, or other type of media sharing, microblogging, or social networking service. The social networking service may allow for merchants and other selling entities to post data, which may correspond to an item for sale. The posts by the seller may further allow other users to comment on the posts of items. The posts may include an image, video, or other data, as well as a description, which may include an item description, price, variations (e.g., size, color, etc.), shipping information, or other sales information. Users may comment on the posts as a process to purchase the item, where the transaction processor may process payments for items requested for purchase by users (e.g., commenters) through a social networking service, as discussed herein.

In this regard, a transaction processor may provide one or more software integration platforms and/or processes, which may be used to integrate a social networking platform for a social networking service with a merchant and/or inventory management system for the merchant, or otherwise assist the merchant in sales through online posts to the social networking platform. In this regard, the integration processes may include both applications and programmatic interfaces, such as one or more application programming interfaces (APIs), to provide merchant sales through a social networking service's platform (e.g., online website/portal, dedicated application, messaging platform or protocol such as SMS/MMS, instant messaging, messaging through an online platform, etc. or other social networking platform). A merchant may first be required to onboard with the service provider, for example, by providing merchant information to the transaction processor and allowing the transaction processor to access and/or utilize an inventory management system or other backend merchant processing and sales system. The merchant may also provide access information to the social networking account of the merchant with the social networking platform, such as authentication credentials and/or authorization through oAuth or other authorization standards that allow access and sharing of data between platforms. In various embodiments, the merchant may provide the authorization through the transaction processor or may select that the social networking platform provide the transaction processor with permission to access the merchant's social networking account, for example, through an account setting. Thus, the merchant may be required to provide social networking information for the social networking account of the merchant, such as a login name, password, or other information necessary to access a non-public social networking account for the merchant.

Where the merchant corresponds to an online merchant having a merchant marketplace or online sales portal, the merchant may allow the transaction processor's integration platform to connect and link to the merchant's online marketplace, sales system, and/or inventory management system. For example, the merchant may provide information (e.g., web/IP address) and/or select the merchant marketplace, which may allow an API of the integration platform to integrate with the merchant marketplace and retrieve item, sales, and/or merchant information. The merchant may further provide authorization, for example, through an authorization standard such as oAuth, to allow access to the marketplace or other sales platform by the integration platform, which may include providing authentication credentials and/or authorizing access and sharing of data. In various embodiments, the integration platform may require the merchant to download and/or install software, such as a software plug-in, that allows the integration platform to pull information from the marketplace, sales platform, and/or inventory management system.

However, in other embodiments, the merchant may not have an online or electronic marketplace or sales platform. For example, single user and small merchants may sell individual or small batches of items, such as a single or small group of clothing or other individual or small grouped items. In such embodiments, onboarding with the integration platform may instead require provision of merchant and item information, such as sales price, image, discounts, inventory, description, shipping/billing information, merchant name/description, or other information. Thus, if the merchant or other selling entity has an inventory management system, the seller may provide access to such a system. However, if the seller does not have such a system, the seller may instead provide details for items sold by the seller, which may be provided through data transmitted to the transaction processor and/or data scraped from a social networking feed or other online resource of the seller. In order to onboard either type of merchant, the integration platform may further request that the merchant provide information and allow the integration platform to link and utilize the merchant's transaction processor. In various embodiments, the merchant's transaction processor may be provided by the service provider, for example, PAYPAL®. However, other transaction processing entities may also be utilized, including merchant specific transaction processing entities. The merchant may provide authorization to utilize the payment processing functions, account, and other services to the transaction processor, which may be recorded as a token or other data and stored by the transaction processor. Thus, the authorization may include a merchant account or payment processing service or other information necessary to process transactions and provide payments to the merchant, which may include the token, a user name and password, or other authentication details for use by the transaction processor.

In various embodiments, the seller may also be required to complete a billing agreement and/or other associated process that sets transaction processing fee structures and payment by the seller to the transaction processor for use of the transaction processing entities systems. The billing agreement may include a one-time fee, per transaction fee, monthly fee, or other fee arrangement between the seller and the transaction processor. The billing agreement may further set standards and limits on use of the seller's data and processes, including updating of the seller's inventory management system and provision of sales statistics between the seller and the transaction processor. The billing agreement may further include authorizations and/or limits on use of the seller's social networking account on the social networking platform, such as permission to edit, generate, and/or delete post, as well as provide automated comments to posts, including updating sales information and/or confirming sales to users. Such permissions may be used by the transaction processor when processing sales of items, creating invoices to users, confirming invoice creation and/or completion to users, and/or updating stock and inventory information for the seller.

Once a seller has been on-boarded with the transaction processor, the transaction processor may determine items for sale by the seller and process the seller's social networking posts to identify the items and process sales based on comments by buyers to the posts associated with the items for sale. For example, the seller may provide item information or may identify items in the marketplace and allow the integration platform to pull relevant information (e.g., price, size, inventory, etc.) from the post. The seller may identify one or more social networking posts, media shares, or other social networking interactions that serve as an advertisement or listing of the item for sale. For example, the seller may identify an image or other data post of the item on a media sharing platfolta, such as INSTAGRAM® or IMGUR®. Thus, the seller may link to the post with the social networking platform that offers the item for sale, which may be done through menu selections, providing a URL or other network address, or otherwise identifying the post. In other embodiments, the seller may not actively identify the post to the transaction processor and may instead publish a post on the social networking platform with a specific tag or identifier, such as a hashtag value, that serves to identify the post as providing an item for sale. The tag may further include information necessary for the transaction processor to identify correct seller and/or item information for sale of the item. For example, a hashtag may be generated by the transaction processor or inventory management system for an item the seller wishes to sell. The seller may then publish a social networking post that includes the hashtag to identify the item for sale. The transaction processor may also provide natural language processing services and processes to identify the item for sale in a post by the seller. In various embodiments, the item information and/or shipping information for the item may be extracted from the hashtag, identifier or post text/data by the transaction processor.

In this regard, the transaction processor may poll, process, or otherwise scrape posts from the social networking platform by the seller to identify items listed for sale, which may be limited to the social networking platform and account for the seller, or may poll/scrape information from all social networking posts on a social networking platform. The transaction processor may include an automated bot, such as a software program, that periodically, intermittently, or continuously scrapes the posts of the seller or on the social networking platform to identify a post that lists an item for sale from the seller's inventory. Thus, one or more processes of the transaction processor may access the seller's social networking account and/or process the posts of the seller to determine posts having items for sale. The onboarding process for the seller may provide seller/item information, payment information, and other information that may be required for the transaction processor to determine posts having items for sale. Once a social networking post is identified as providing an item for sale, the integration platform may monitor the social networking post to determine purchase requests for the item.

The transaction processor may then further monitor and poll comments from social networking posts by the user that identify one or more items for sale in the posts. The transaction processor may view and process comments by other users, where data in the comments by one or more other users acts as a purchase request by the user(s) to purchase the item from the merchant. For example, a comment with a tag or identifier, such as a hashtag value or text, within the comment's body/post may serve as an initiation of a purchase request to purchase the item from the merchant. In such embodiments, the commenter (e.g., the buyer or user) may state something such as #purchase or #buy, which may initiate the purchase request. The merchant may provide instructions for what to post to initiate the purchase request in the post of the item by the merchant, which may further be utilized by the transaction processor to determine whether a user is requesting a purchase. In this regard, a user acting as a buyer may also be required to onboard with the transaction processor. For example, the user may provide information for a social networking account for the user to a transaction processor and/or the integration platform to link a payment account for the user with the transaction processor to the social networking account of the user with the social networking platform. The user may provide access credentials (e.g., user name, password, PIN, etc.) to the transaction processor, or may allow authorization through oAuth or other authorization standard with the social networking platform to allow the transaction processor to access user data and view user comments. The user may provide, or may allow access from the social networking platform, to a contact identifier or address of the user, which may be used to invoice the user for purchases and/or transmit transaction histories.

The user may further provide authorizations to the transaction processor to allow purchases through comments by the user. In various embodiments, the user may perform this onboarding prior to commenting on a merchant post to purchase an item, or may perform the onboarding when first providing a comment to a post. For example, the user may select a link (e.g., a hyperlink to a payment portal for the merchant and/or for the transaction processor) that directs the user to the onboarding process. In other embodiments, an invoice with the item for sale and onboarding process may be communicated to the user for viewing when the user comments with a hashtag or other value using the user's online identifier for user's account with the social networking platform. The user may then further authorize payments using just comments having a purchase request identifier. In other embodiments, the user may access the transaction processor to link the social networking and payment accounts of the user and perform various opt-in to comment purchasing. Once onboarded, the user may then view the item for sale and/or merchant information and authorize one or more payments to the merchant through a comment with the appropriate comment data to initiate the purchase request.

The user and/or the merchant may further be required to establish an account with the transaction processor in order to engage in transaction processing. The user and/or the merchant may be required to provide personal, business, or other identification information to establish the account, such as a name, address, Employer Identification Number (EIN), and/or other information. The user and/or the merchant may also be required to provide financial information, including payment cards (e.g., credit/debit cards), bank account information, gift cards, and/or benefits/incentives, which may be utilized to provide payments or otherwise engage in processing of another transaction. In order to create an account, the user and/or the merchant may be required to select an account name and/or provide authentication credentials, such as a password, personal identification number (PIN), security questions, and/or other authentication information. The transaction processor may utilize such information to create the account for the user, and provide the user with a digital wallet that allows for electronic transaction processing. The digital wallet may store the user's financial instruments of the user and allow the user to process transactions through the digital wallet. In this regard, the transaction processor may provide a digital token, such as a data package, that represents the digital wallet and may approve the digital wallet for processing of a transaction with the transaction processor to a device that receives the token. Thus, the token may include data identifying the digital wallet (e.g., a token), as well as authentication information including an identifier for the user of the digital wallet, which may be encrypted.

Once an account is created, the account may be accessed through a web browser from a website of the transaction processor and/or a dedicated application of the transaction processor, such as a mobile smart phone application. The user and/or the merchant may engage in transaction processing through accessing their respective accounts and providing transaction information for the transaction. Thus, the aforementioned token may be issued to the user and/or the merchant for their respective accounts, where the token may include data (which may be encrypted) allowing the transaction processor to identify the user and/or the merchant and their account, as well as authenticate the user and/or the merchant. As such, the token may be transmitted to other entities during transaction processing, which may allow the service to identify and authenticate the user's and/or the merchant's account and engage in transaction processing. Thus, the accounts may store information associated with each user, merchant, or other entity for use in transaction processing.

In this regard, a computing device for a user and/or a merchant, such as a communication device of a user or a point-of-sale device of a merchant, may further include a mobile payment application or more generally a transaction processing application, which may be configured to send and receive payments to another party, such as another user and/or a merchant, or otherwise engage in transaction processing. In various embodiments, a website may provide the transaction processing services, and thus may be accessed by a web browser application. The application (or website) may be associated with the transaction processor, e.g., a payment provider, such as PAYPAL® or other online payment provider service, which may provide payments and the other aforementioned transaction processing services on behalf of user, merchants, and other entities. The application may execute on the computing device for a user or a merchant, and may provide various functionalities and processes to the user and/or merchant. For example, a user may utilize the application to send and/or receive payments between the user and another user/merchant for one or more items purchased in a transaction. The merchant may similarly send and/or receive payments between the merchant and another user/merchant, which may include receiving payment for transactions.

The transaction processor may provide for tokenized payments utilizing payment information provided by a user, for example, during an initial setup process for social networking payment and/or where a user may access the integration platform based on a received invoice to provide or update payment information. In various embodiments, the integration platform may assist in network tokenization of the user's funding instrument (e.g., a credit card) or other payment details. Network tokenization may allow consumers and users to register their payment cards with a mobile wallet or online store, and replace the user's actual card number with a payment token number which can be used anywhere credit cards are accepted. Such tokenization provides consumers and users with increased protection against counterfeiting, account misuse, and other forms of fraud. Also, tokenization provides merchants, users, and transaction processing entities the flexibility to utilize different payment token numbers per merchant or even per transaction. Upon creation of a payment by the integration platform, the integration platform may tokenize the payment details, such as the user's credit card number, before transmission to the transaction processor. The transaction processor may then translate the tokenized payment details back to the user's credit card number to process the payment with the credit card issuing bank or other financial institution.

In various embodiments, BRAINTREE®, PAYPAL® or other transaction processing entities may be used as token service providers, which may allow third parties to create transactions within a third party channel (e.g., through a social networking platform and/or with a third party merchant transaction processor system), without having direct access to the user's credentials. Thus, the user may issue the token during transaction processing through a third party channel in order to perform transaction processing. In various embodiments, tokenization occurs using a POST request from the user to a tokenization service provider to tokenize a primary account number (e.g., a credit card number). The request may include a merchant identification for a merchant vault to be accessed, a payment method nonce for a payment instrument being tokenized, a payment method token of the payment instrument being tokenized, the maximum amount a primary account number can be charged, and a currency code the maximum amount should apply to (e.g., USD, JPY, etc.). The request may also include the expiration date and card security code (e.g., CVV) for the primary account number. The response to the request may include a tokenized primary account number, along with a card security code and expiration date for the tokenized primary account number. Errors may occur when attempting to tokenize a payment instrument that cannot be tokenized, or if a tokenization failure occurs.

In various embodiments, network tokenization may involve a sequence of operations between a third party channel (e.g., e.g., through a social networking platform and/or with a third party merchant transaction processor system), transaction processor (in one example, BRAINTREE®), tokenization provider (in one example, PAYPAL®), and a merchant. The third party channel may request that the transaction processor vault a particular user's payment method (e.g., credit card). In response, the transaction processor may send the third party channel a payment method token. The third party channel may then send the token, and request a tokenized card to be sent. The transaction processor, upon receiving the token and request, itself requests a network tokenized card from the tokenization provider, which sends back the network tokenized card. The transaction processor may then send the network tokenized card to the merchant, which processes the network tokenized card, and sends the transaction processor a response. The response is then passed to the third party channel.

In various embodiments, network tokenization may involve a sequence of operations between a third party channel application executing on a client device, a third party channel server (e.g., through a social networking platform and/or with a third party merchant transaction processor system), and a transaction processor (e.g., BRAINTREE®). The third party channel application executing on the client device may transmit credit card or transaction processor account details to the transaction processor, which in turn may respond with a nonce to the application. A nonce may represent, for example, a type of payment method (e.g., credit card, PayPal account, Bitcoin account, other cryptocurrency account, etc.). The application may request that the third party channel server vault the nonce; in response, the third party channel server may transmit the request to vault the nonce to the transaction processor. Upon successful vaulting of the nonce, the transaction processor may provide the third party channel server with a payment method token which may be used for purchasing products by the user. In various embodiments, tokens have an expiration date, which may be roughly 60 days after issuance. In various embodiments, the expiration threshold or timeout may be smaller than 60 days. Once a token is expired, in various embodiments, a new token may be obtained for each request. Alternatively, tokens may be obtained, cached, and handled upon expiration.

In various embodiments, a merchant or retailer token may be requested by the third party channel, which can then be used to make calls to the APIs of the transaction processor for a particular merchant. In various embodiments, the request for a merchant electronic commerce platform token includes the third party channel's client identifier and a client secret, and may further include an identifier for the merchant or merchant electronic commerce platform (such as a domain name for the merchant) and an identifier for the third party channel. In response, the integration platform may provide an access token and an expiration time for the access token. In various embodiments, the requests and responses are transmitted as POST HTTP requests in JSON (JavaScript Notation) format. In various embodiments, the access token is cached. Upon expiration of the access token, calls to the APIs of an integration platform may return an HTTP 403 status code. In various embodiments, once a token expires, the third party channel may request a new access token and cache the access token again. In various embodiments, merchants may need to opt-in to enable purchasing through a third party channel. Thus, if a third party channel were to request a token for a merchant that had not authorized the third party channel, an HTTP error status code may be returned, such as an HTTP 400 status. In various embodiments, if a merchant revokes the grant of a token, which the merchant may do at any time, requests made with the token may result in an HTTP 403 status, and requests for new tokens may result in an HTTP 400 status.

Thus, while monitoring the social networking post, the transaction processor may determine whether any users comment on the social networking post with the tag or identifier indicating a purchase of the item by the user. For example, a user wishing to purchase the item may provide the tag or identifier per the instructions of the merchant/seller in the social networking post. Use of the tag or identifier may cause the transaction processor to generate a purchase request for the item. Additional information in the social networking comment may be used to provide options for purchase, such as size, color, shape, model, quantity, or gender specification, as well as shipping instructions (e.g., 2-day, pick up, etc.), or other purchase instructions. Thus, the user may specify variations on the purchase order and/or item through additional data within the comment. Once the purchase request is identified, an invoice to purchase the item may be generated based on the tag and any data from the social networking post on variations for purchase. An electronic invoice or other type of electronic purchase order or form may be generated for the user that allows the user to purchase the item. The invoice may be transmitted to the contact address for the user set with the transaction processor. The invoice may correspond to a message having one or more processes, links, or information that may be used to process a payment and purchase the item specified by the user in the comment. The invoice may be accessible through the user's account with the transaction processor, which may allow for transaction processing and payment, as described above.

In various embodiments, prior to generating the invoice, the transaction processor may access the merchant's inventory management in order to determine inventory of the item, including inventory of any variations on the item that are specified by the user. The invoice or other type of purchase order form may be generated in response to available inventory with the inventory management system. In embodiments where a merchant has an online ecommerce sales platform, the transaction processor may pull information from the merchant's platform to provide product sales. To obtain products which can be purchased, the transaction processor may issue a request to the API of the merchant's platform, such as the inventory management system. In many cases, a product may be shared using a web URL. The transaction processor may determine whether or not the product is sellable by retrieving product information from the inventory management system API. For example, if a merchant utilizing the third party channel creates a post and shares a link to a shirt at a given URL on a social networking platform, the third party channel may issue a GET request to the inventory management API using the URL for the shirt and/or an identifier within the post. If the merchant for the URL is registered with the transaction processor and opted-in to selling through the transaction processor, the inventory management system may respond with the information needed to provide the item for sale.

The response to the GET request may include various elements of data, in a JSON formatted response, for the shirt, such as a high price, a high suggested price, a product type name, a low price, whether the product requires shipping, an address for images of the product and characteristics of the images, whether the product is in stock, variants (e.g., size, color) of the product, inventory information for the product, a SKU identifier, descriptive text, a name for the product, a UPC for the product, keyword information for the product, and any other information provided by the merchant electronic commerce platform. In various embodiments, each product variant (e.g., different color, size, texture, etc.) may have its own SKU or unique identifier. For example, a black t-shirt sold by a retailer that is available in small and medium may have a SKU for each size. When a user decides to place an order through a comment to the merchant post, the SKU for the specific variant may be used in the order process, which may be identified based on the data within the comment by the user. In various embodiments, responses from a GET request may be cached for a period of time, such as five minutes, hours, or days. In various embodiments, if the user proceeds to order the product, up-to-date (i.e., non-cached) information is retrieved to obtain the full cost for the purchase.

In various embodiments a simple GET request may request all available products from a merchant, using an access token for the merchant (e.g., “GET/products HTTP/1.1” submitted with an access token). The transaction processor transmits a request using its access token, and the inventory management system responds with details for the requested product. In various embodiments, product listings may be paginated and filtered by various criteria, such as a category, UPC, SKU, name, or description. In various embodiments, a page size may be changed by utilizing a query string parameter (e.g., “GET/products?per_page=20 HTTP/1.1” submitted with an access token). For example, a default page size may return 12 products, and a response time may increase if additional products are requested. To retrieve subsequent pages (e.g., the 21^{st}-40^{th} product), a page query string parameter (e.g., “GET/products?per_page=20&page=2 HTTP/1.1” submitted with an access token) may be utilized, indexed starting at 1. In various embodiments, filtering a product listing using a free form query (e.g., across product names, descriptions, UPCs, and SKUs) a “q” parameter may be used (e.g., “GET/products?q=frozen&per_page=40&page=2 HTTP/1.1” submitted with an access token). Other filters may allow searching by category or category slug, the name field of products, the description field of products, whether a product is in stock, a SKU, or a UPC. In various embodiments, such searches may return a “count” of the number of matched record. In various embodiments, results of such a query may return multiple products with the “best” match as the first result.

In various embodiments, a specific product may be returned to retrieve, among other information, a purchase cost for a particular product, given a shipping location. For example, when a customer or user intends to purchase a product, an accurate snapshot of the costs to be incurred is likely necessary. The costs include a combination of the price of the product itself along with sales tax and shipping costs. Sales tax and shipping costs may be determined by the physical location of the merchant and where the product will be shipped. Physical locations of merchants, tax overrides, and shipping rates may be maintained by the integration platform. Once the integration platform receives the location of the desired shipment, which may include, for example, a postal code and country, the transaction processor and/or inventory management system (or other merchant system/platform) may determine the shipping cost and total cost. In various embodiments, to obtain the full cost, a request is made to an endpoint for the specific product and variant of that product (using, for example, the SKU for the variant), and the request may include a postal code and country code query string parameters to indicate the destination. The parameters may allow the API to determine whether or not the merchant ships to the requested location, and what taxes and shipping costs may be assessed if the product is purchased. The transaction processor transmits a request using its access token, the variant, a postal code and country code for shipping, and the inventory management system responds with details for the requested purchase, including the price for the variant, shipping cost, taxes, a total cost for the purchase, and whether the product is shippable to the requested country and postal code. To retrieve a purchase cost for a particular product, given a shipping location, a GET request may be made with a shipping country variable in a valid ISO 3166-1 2 letter code, for example, as follows: “GET/products/JUNIOR-PHASER?shipping_zipcode=60647&shipping_country=US HTTP/1.1” with an access token. The response may appear similar to a product listing response, but with additional top-level key data containing the shipping, tax, and total costs if the customer were to purchase the product and ship it to the zip code and country contained in the request.

Once a cost is generated and available inventory is determined, an invoice or other electronic payment form may be generated for the user to be paid with an account using the transaction processor. However, if available inventory of the item does not exist, the user may be notified through a communication back to the user, for example, at the contact address entered by the user, through the social networking account, to the account of the user with the transaction processor, and/or as a reply to the user's comment on the social networking post that identified the purchase request. Thus, the transaction processor may have authorization to post replies to user comments and/or otherwise comment or place posts to the merchant's social networking account.

In certain embodiments, the user may also receive the invoice and may be required to approve the invoice for payment. In various embodiments, the purchase request may be processed using the transaction processor, for example, by withdrawing funds from the account of the buying user and depositing the funds to the account of the merchant. Additionally, once a payment is processed, a transaction history may be provided to the merchant, which may include purchase information (e.g., user name, shipping address, payment amount, etc.) that allows the merchant to fulfill sales of the item and provide the item to the user. A similar transaction history or receipt may be provided to the user, which as a SMS/MMS (text message) receipt, email receipt, or other opted-in communication documenting the sale of the item. Upon creation of an order in an invoice by the transaction processor and processing of payment for the invoice, a transaction history or other information for the invoice and processed payment is transmitted to the merchant's electronic commerce platform or inventory management system, which may begin fulfilling the order immediately. The order identifier may be stored by the transaction processor and may be used as a reference when communicating order status to the inventory management system. The transaction processor API may return a response that includes an HTTP 201 status code, and full cost information associated with the order, for example, a breakdown of the price for the product variant, the quantity ordered, the shipping cost, any taxes, and a total cost variable. Once the merchant fulfills a purchase facilitated by the transaction processor API through the social networking platform, a webhook message that includes the order identifier and a status identifier (e.g., “fulfilled”) may be delivered by the transaction processor API. Additionally, the inventory management system may respond with a confirmation of an inventory hold, or the transaction processor API may request to the inventory management system to place an inventory hold. Shipment details, including the customer, address, and product, may be transmitted from the transaction processor system to the merchant's sales platform and/or inventory management system, and in response, the merchant's platform and/or inventory management system may respond with a confirmation of the order. The transaction processor API may also update the inventory management system or request on update of the inventory management system to reflect the order and currently available inventory, where applicable.

In various embodiments, a shipping address for a user may include component variables such as a customer's first name and last name, the customer's street address and extended address (e.g., unit or apartment number), a locality (e.g., city), a region (e.g., state), a postal code, an alphanumeric country code, and a phone number. Certain component variables may be optional in some embodiments. In various embodiments, if an error occurs during order creation, the transaction processor API may return a HTTP 400 status code, along with a JSON formatted response body indicating why the error occurred. Common errors may be the result of improperly formatted request bodies, SKUs not existing, products out of inventory, merchant limitations on shipping destinations, revocation or expiration of access tokens, and payment failures.

Additionally, the transaction processor may monitor the social networking post to see if the merchant provides a further tag, comment, or instruction to otherwise adjust the item for sale, for example, by identifying a different item for sale (e.g., the original posted item in a different color/size/etc.) or ending sales of the item (e.g., no more inventory). In other embodiments, the transaction processor may end the sales where inventory has been exhausted or the item has changed.

System 100 includes a communication device 110, a merchant device 120, and a transaction processor server 140 in communication over a network 150. A user (not shown) may establish a user payment account with transaction processor server 140, which may be linked to a social networking account and used to purchase items on a social networking platform through comments to one or more social networking posts. The comments requesting purchase of an item may be identified using a hashtag, statement, identifier, or other data entered to the comment that is associated with a purchase request for the item. A merchant (not shown) corresponding to merchant device 120 may provide one or more items for sale through the social networking platform, for example, by linking the merchant's social networking account to an account with transaction processor server 140, as well as further linking the social networking account to a merchant marketplace, inventory management system, and/or other platform that provides information and data on items for sale from the merchant. Thus, transaction processor server 140 may provide integration for the merchant's sales and social networking account/posts (e.g., through an integration platform having processes and features to integrate the merchant's inventory with the social networking account and posts). Transaction processor server 140 may monitor social networking posts by the merchant for items for sale from the merchant and determine whether the user posts a comment on a post by the merchant requesting purchase of the item. Once a purchase request comment by the user to a post of the merchant is detected, transaction processor server 140 may generate an invoice and process a payment between the user and the merchant.

Communication device 110, merchant device 120, and transaction processor server 140 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or, external to various components of system 100, and/or accessible over network 150.

Communication device 110 may be implemented as a communication device that may utilize appropriate hardware and software configured for wired and/or wireless communication with transaction processor server 140 and/or merchant device 120. For example, in various embodiments, communication device 110 may be implemented as a personal computer (PC), a smart phone, laptop/tablet computer, wristwatch with appropriate computer hardware resources, eyeglasses with appropriate computer hardware (e.g. GOOGLE GLASS®), other type of wearable computing device, implantable communication devices, and/or other types of computing devices capable of transmitting and/or receiving data, such as an IPAD® from APPLE®. Although a communication device is shown, the communication device may be managed or controlled by any suitable processing device. Although only one communication device is shown, a plurality of communication devices may function similarly.

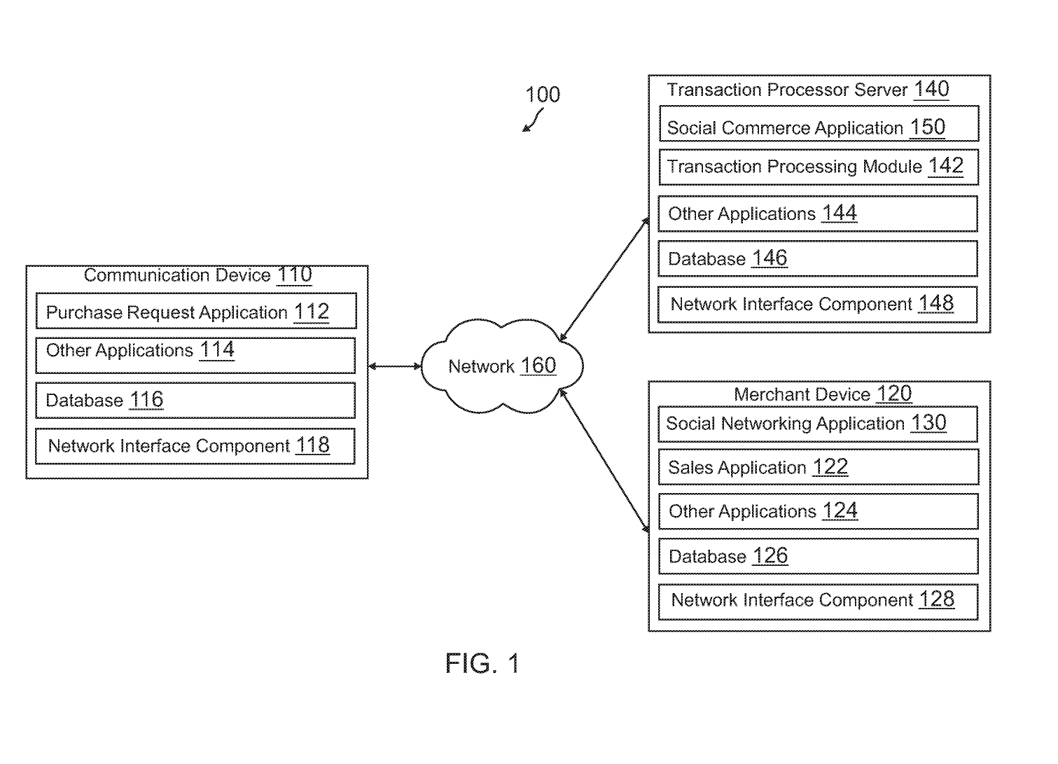

Communication device 110 of FIG. 1 contains a purchase request application 112, other applications 114, a database 116, and a network interface component 118. Purchase request application 112 and other applications 114 may correspond to executable processes, procedures, and/or applications with associated hardware. In other embodiments, communication device 110 may include additional or different modules having specialized hardware and/or software as required.

Purchase request application 112 may correspond to one or more processes to execute modules and associated devices of communication device 110 to access a social networking service and purchase items from posts using the social networking service by a merchant associated with merchant device 120. In this regard, purchase request application 112 may access a social networking platform or other online service and allow the user to browse posts on the social networking platform. In various embodiments, purchase request application 112 may allow the user associated with communication device 110 to establish an account with the social networking platform as well, for example, to provide user information, posts, media, and/or comments or other additions to posts on the social networking platform. Purchase request application 112 may allow for navigation between social networking posts, as well as account searching and subscription services, for example, to locate an account of another entity (e.g., the merchant) and/or follow the account of the merchant or other user/seller on the social networking service. In various embodiments, purchase request application 112 may correspond to a general browser application configured to retrieve, present, and communicate information over the Internet (e.g., utilize resources on the Internet) or a private network. In other embodiments, purchase request application 112 may include a dedicated application of the social networking service, which may be configured to access a social networking service and purchase items through comments by the user associated with communication device 110.

Purchase request application 112 may be used to post or provide a purchase request for an item on the social networking service by providing, from the user, a comment or other addition to a post by a merchant on the social networking service. The post may therefore advertise the item for sale, for example, through post data by the merchant (e.g., images, text, media, etc.). Transaction processor server 140 may identify the post as advertising sale of the item through the post data, as discussed herein. The comment may be provided by the user accessing, using purchase request application 112, the post by the merchant on the social networking platform and entering data to a field or other input accepting area of the post. The data may include text data, as well as media, links, identifiers, and/or hashtags. Therefore, a comment by the user may include a hashtag or identifier as per the instructions of the merchant/seller in the post or otherwise provided by the merchant (e.g., in an account/profile of the merchant). The tag may correspond to a hashtag value instructed by the merchant, and may be scraped/polled by transaction processor server 140 to generate a purchase request or invoice for the user that is used to process a transaction to purchase the item in the post, as discussed herein. The invoice may be processed using a payment account for the user. For example and as discussed herein, transaction processor server 140 may be used to provide payment to the merchant associated with merchant device 120. Purchase request application 112 or another application (e.g., other applications 114) may therefore be used to provide payment information for use in processing the payment.

Thus, in various embodiments, purchase request application 112 (or other applications 114) may correspond to specialized hardware and/or software utilized by communication device 110 to provide an interface to permit the user associated with communication device 110 to select payment options and provide payment for an item or items in an invoice, for example, to a merchant through merchant device 120 using transaction processor server 140. Purchase request application 112 may be implemented as a user interface enabling the user to enter payment options, select and provide payment options on checkout/payment of one or more items with a merchant, and complete a transaction for the item(s) through a purchase request for the item(s). Purchase request application 112 may also be used to establish a user account, such as a payment account, with transaction processor server 140 to provide payments through the payment account. Purchase request application 112 may be used to link the payment account and one or more social networking accounts for the user. Moreover, purchase request application 112 may be used to opt-in to purchasing through comments on social networking posts by merchants, for example, by providing authorizations to transaction processor server 140 (e.g., authorizations to utilize a payment account to provide payments, access one or more user accounts, etc.). In various embodiments, the authorization and/or opting-in process may be performed through selection of one or more account options for the user's account on the social networking platform. Purchase request application 112 may utilize user financial information, such as a credit card, bank account, or other financial account, as a payment instrument when providing payment information for use in a purchase request generated through a social networking comment. Additionally, purchase request application 112 may utilize a user account with transaction processor, such as transaction processor server 140, as the payment instrument. Purchase request application 112 may be utilized to view the results of the transaction and/or for viewing and storage of a transaction history, such as a receipt. In other embodiments, another messaging application may present the transaction history.

In various embodiments, communication device 110 includes other applications 114 as may be desired in particular embodiments to provide features to communication device 110. For example, other applications 114 may include security applications for implementing client-side security features, programmatic client applications for interfacing with appropriate application programming interfaces (APIs) over network 150, or other types of applications. Other applications 114 may also include email, texting, voice and IM applications that allow a user to send and receive emails, calls, texts, and other notifications through network 150. Other applications 114 may include payment applications, for example, when such features are not provided by purchase request application 112. In various embodiments, other applications 114 may include financial applications, such as banking, online payments, money transfer, or other applications. Other applications 114 may also include other location detection applications, such as a mapping, compass, and/or GPS application. Other applications may include social networking applications and/or merchant applications. Other applications 114 may include device interfaces and other display modules that may receive input and/or output information. For example, other applications 114 may contain software programs, executable by a processor, including a graphical user interface (GUI) configured to provide an interface to the user.

Communication device 110 may further include database 116 stored to a transitory and/or non-transitory memory of communication device 110, which may store various applications and data and be utilized during execution of various modules of communication device 110. Thus, database 116 may include, for example, identifiers such as operating system registry entries, cookies associated with purchase request application 112 and/or other applications 114, identifiers associated with hardware of communication device 110, or other appropriate identifiers, such as identifiers used for payment/user/device authentication or identification. Information for execution of purchase request application 112 may be stored to database 116, including account logins, payment information, and other information used to purchase through a social networking platform. Database 116 may include transaction information, as well as payment instruments for a transaction. Additionally, received transaction histories may be stored to database 116.

Communication device 110 includes at least one network interface component 118 adapted to communicate with merchant device 120 and/or transaction processor server 140. In various embodiments, network interface component 118 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Merchant device 120 may be maintained, for example, by a merchant or other entity selling one or more items to users, which may include single or groups of independent users as well as small and large branded merchants. Merchant device 120 may also interact with transaction processor server 140 to provide the items for sale using an online social networking platform. In this regard, merchant device 120 may include a device having processing applications, which may be configured to interact with communication device 110 and/or transaction processor server 140 to engage in transactions for items advertised for sale through one or more social networking posts. Merchant device 120 may be implemented using any appropriate hardware and software configured for wired and/or wireless communication with communication device 110 and/or transaction processor server 140. For example, in various embodiments, merchant device 120 may be implemented as a single or networked personal computer (PC), a smart phone, laptop computer, wearable computing device, and/or other types of computing devices at a merchant location capable of transmitting and/or receiving data. Although a merchant device is shown, the merchant device may be managed or controlled by any suitable processing device. Although only one merchant device is shown, a plurality of merchant devices may function similarly.

Merchant device 120 of FIG. 1 contains a social networking application 130, sales application 122, other applications 124, a database 126, and a communication module 128. Social networking application 130, sales application 122 and other applications 124 may correspond to processes, procedures, and/or applications executable by a hardware processor, for example, a software program. In other embodiments, merchant device 120 may include additional or different modules having specialized hardware and/or software as required.

Social networking application 130 may correspond to one or more processes to execute modules and associated specialized hardware of merchant device 120 to provide access to a social networking platform or other online service and provide posts, or online data available for lookup and viewing, to the social networking platform by the merchant (or other selling entity) associated with merchant device 120. The posts may be associated items for sale by the merchant on the social network, and may be posted to the merchant's account so that they are associated with the merchant's account and may be viewed when looking up the merchant's account and/or subscribing to posts in a feed for the merchant's account. In this regard, social networking application 130 may access a social networking platform and post text, images, videos, or other content on the social networking platform. Thus, social networking application 130 may correspond to an online platform, such as a media sharing, microblogging, or other online social network. Social networking application 130 may be used to establish a social networking account with the social network, as well as provide various account information, including as personal, merchant, and/or financial information. Social networking application 130 may also be used to generate a portal and/or profile for the merchant, as well as direct other users (e.g., buyers) to the merchant's profile and allow the users to search for, follow, subscribe, or otherwise find the merchant associated with merchant device 120.

The merchant may further utilize social networking application 130 to access the merchant's social networking account and provide posts to the merchant's profile, page, or portal. Other users may view the posts and comment on the posts, as described herein. The merchant may utilize social networking application 130 to provide information in the posts that is associated with items for sale by the merchant, such as item information (e.g., price, size, color, shipping information, expected delivery time, etc.) and/or directions for purchasing through a comment (e.g., a necessary hashtag to initiate a purchase request for the item using transaction processor server 140). Thus, when the user associated with communication device 110 provides a comment with the appropriate tag or identifier, an invoice may be generated based on the purchase request, and the invoice may be processed using sales application 122 and/or transaction processor server 140. The posts may be processed by transaction processor server 140 to determine what item is advertised for sale, as well as identify purchase requests by commenting users and generate invoices for those users, as discussed herein. Additionally, in order to sell one or more items available from the merchant, the merchant may link, using transaction processor server 140, the social networking account of the merchant with social networking application 130 with a merchant marketplace, inventory management system, or other sales portal associated with sales application 122.

In this regard, sales application 122 may correspond to one or more processes to execute modules and associated specialized hardware of merchant device 120 that provide sales and payment processes for a transaction to purchase one or more items for sale from the merchant corresponding to merchant device 120. In this regard, sales application 122 may correspond to specialized hardware and/or software of merchant device 120 to provide a marketplace, inventory management system, or other sales portal, processes, or features to permit a merchant offer items for sale. Sales application 122 may be used to establish a transaction once an invoice is generated, where the invoice is generated by transaction processor server 140 from a comment by the user associated with communication device 110 to a social networking post by the merchant.

The inventory information and/or management system available with sales application 122 may be linked to the merchant's social networking account, and transaction processor server 140 may make API calls or other data requests for sales application 122 when generating an invoice. For example, transaction processor server 140 may utilize post data to a post to determine the post is linked and advertising an item for sale available from sales application 122, such as through a description, item identifier, image, or other posted data that is linked to the item available from sales application 122 and/or the merchant's inventory management system. Transaction processor server 140 may further request data to determine if the item is in stock, and whether the variations (e.g., size, color, etc.) are available for the user's requested purchase of the item. Where the item is available, transaction processor server 140 may generate the invoice. However, if the item is unavailable, transaction processor server 140 may reply to the user and/or edit/close the social networking post selling the item, as discussed herein. Transaction processor server 140 may further request item information to generate the invoice, including a price, shipping information, delivery timelines, etc., when generating the invoice.

The invoice may include a name of the user, shipping information, and/or other necessary information to provide the item to the user. In various embodiments, the invoice may also include payment processes and/or information necessary to authorize and/or process a payment by the user to the merchant. In certain embodiments, sales application 122 performs payment processing using transaction processor server 140, however, in other embodiments, transaction processor server 140 may process a payment by the user to an account of the merchant with transaction processor server 140. The invoice may be transmitted to the user and/or the merchant, where the user is required to view, authorize, and complete the invoice. Once a payment amount is determined for the transaction for the item(s) to be purchased by user 102, the invoice may request payment from user 102. The invoice may then be processed after user authorization and payment instrument selection, and payment is provided to the merchant account. Notification of payment (or failure, for example, where there are insufficient user funds) may be sent to sales application 122. Sales application 122 may then receive the results of the transaction processing, and complete the transaction with user 102, for example, by providing the user the items for the transaction. Sales application 122 may further be used to update inventory or otherwise adjust a merchant marketplace also selling the item. However, in other embodiments where the merchant does not have or utilize a sales marketplace, sales application 122 may instead act as a messaging, email, or other communication application to notify and provide the invoice to the merchant, or as a payment application to process received invoices with transaction processor server 140.

Merchant device 120 includes other applications 124 as may be desired in particular embodiments to provide features to merchant device 120. For example, other applications 124 may include security applications for implementing client-side security features, programmatic client applications for interfacing with appropriate application programming interfaces (APIs) over network 150, or other types of applications. Other applications 124 may also include email, texting, voice and IM applications that allow a user to send and receive emails, calls, texts, and other notifications through network 150. In various embodiments, other applications 124 may include financial applications, such as banking, online payments, money transfer, or other applications associated with transaction processor server 140. Other applications 134 may contain software programs, executable by a processor, including a graphical user interface (GUI) configured to provide an interface to the user.

Merchant device 120 may further include database 126 which may include, for example, identifiers such as operating system registry entries, cookies associated with sales application 122 and/or other applications 124, identifiers associated with hardware of merchant device 120, or other appropriate identifiers, such as identifiers used for payment/user/device authentication or identification. Identifiers in database 126 may be used by a payment/credit provider, such as transaction processor server 140, to associate merchant device 120 with a particular account maintained by the payment/credit provider. Item information for items sold by the merchant associated with merchant device 120 may be stored to database 126. Thus, database 126 may include data for an inventory management system that may be used to provide data on items for sale when requested by transaction processor server 140. Database 126 may further include transaction information and/or results, including transaction histories.

Merchant device 120 includes at least one communication module 128 adapted to communicate with communication device 110 and/or transaction processor server 140. In various embodiments, communication module 128 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Transaction processor server 140 may be maintained, for example, by an online payment service provider, which may provide payment services and/or processing for financial transactions on behalf of users. In this regard, transaction processor server 140 includes one or more processing applications which may be configured to interact with communication device 110 and/or merchant device 120 facilitate payment for a transaction, including establishment of payment accounts and generation of invoices for social networking purchasing. In one example, transaction processor server 140 may be provided by PAYPAL®, Inc. of San Jose, Calif., USA. However, in other embodiments, transaction processor server 140 may be maintained by or include a credit provider, financial services provider, financial data provider, and/or other service provider, which may provide payment services to the user.

Transaction processor server 140 of FIG. 1 includes a social commerce application 150, a transaction processing application 142, other applications 134, a database 146, and a network interface component 148. Social commerce application 150, transaction processing application 142, and other applications 144 may correspond to executable processes, procedures, and/or applications with associated hardware. In other embodiments, transaction processor server 140 may include additional or different modules having specialized hardware and/or software as required.

Social commerce application 150 may correspond to one or more processes to execute modules and associated specialized hardware of transaction processor server 140 to provide a platform, processes, and/or features that allow a merchant to sell one or more items through one or more online social networking platforms, for example, by posting data to the social networking platform that advertises the item(s) for sale. In this regard, social commerce application 150 may correspond to specialized hardware and/or software to first onboard a merchant with social commerce application 150, for example, by requesting the merchant provide merchant and item information, or authorizations to access the merchant's marketplace or inventory management system that includes the merchant and item information when applicable. Such authorizations may be done through a portal provided by social commerce application 150, and may allow social commerce application 150 to access and/or receive item information during generation of invoices based on user purchase requests of items for sale on the social networking platform. Additionally, the merchant may be required to establish, provide information for, and/or link the merchant's accounts, including a payment or financial account to receive payments from users and one or more social networking account where the merchant will post data accessible by users for items for sale. For example, the merchant associated with merchant device 120 may be required to establish a payment account or login to the payment account to opt-in to social commerce purchasing through one or more social networking platforms. The merchant may further be required to provide authorizations to access and/or utilize the social networking platform, which may correspond to an authorization standard such as oAuth and/or provision of login details for the merchant's social networking account. Once the merchant in on-boarded with social commerce application 150, the merchant may provide sales through the social networking platform. Although the integration platform provided by social commerce application 150 is discussed as internal to transaction processor server 140, in other embodiments, other service providers may utilize or provide the integration platform (e.g., social networking platforms).

In certain embodiments, in order to provide sales through one or more social networking posts, the merchant may be required to identify an item for sale, as well as provide item information (sales price, inventory, description, size/color, etc.). Social commerce application 150 may further generate a tag to identify the item for sale, or may allow the merchant to provide the tag (e.g., a hashtag value, identifier, or other data that may be used by transaction processor server 140 to identify a post of data on a social networking platform that advertises the item for sale). Thus, the tag may identify the item for sale, so that when the tag is added to a social networking post, social commerce application 150 may identify that post, and subsequent comments with purchase requests, as associated with the item and identifying a sale of the item. The merchant may then insert the tag to a social networking post, as described herein. Social commerce application 150 may further generate or allow the merchant to specify a further tag or identifier, such as a hashtag value (e.g., #purchase), that a user may utilize to generate a purchase request for the item by inserting the tag into a comment to the social networking post having the item tag. In other embodiments, the purchase tag may be general or universally used, which users may previously be aware of and utilize. The purchase tag may also be provided with instruction of how to comment to the social networking post in order to request a purchase of the item. Such comments by users in response to the post may initiate a purchase request to purchase the item by the user, for example, by utilizing a payment account of the user to provide a payment to the merchant using transaction processing application 140.

However, in other embodiments, the tag may be previously generated by the merchant and provided with an inventory management system, such as a stock keeping unit (SKU) code or identifier, or other inventory management system data. In certain embodiments, the merchant may not be required to provide a tag in a post, and social commerce application 150 may instead using a description of the item provided in the post's data, an image or other media of the item, or other identifying characteristics of the item that may be added to the post's data. Social commerce application 150 may utilize the identifying data when polling or processing the merchant's posts to determine which posts are advertisements and what items the advertising posts are providing for sale. The post data may further include any variations on the item, including size, color, etc., which may further be requests through users' purchase request comments. Social commerce application 150 may process both the posts and the comment to identify variations for sale and requested purchases of those variations.

In this regard, social commerce application 150 may scrape or poll information from a social networking service that has posts by the merchant for one or more items for sale. Social commerce application 150 may pull information only from the merchant's social networking account and posts or may poll information from all or a subset of posts to the social network. When social commerce application 150 detects an item for sale in a social networking post (e.g., using the tag, identifier, or other item data), social commerce application 150 may poll the comments section to the social networking post to detect whether any user has commented with a purchase request (e.g., through a hashtag or other instructed comment data that initiates a purchase of the item, including any comment data to purchase variations of the item). Where one or more users are detected as commenting with a purchase tag, social commerce application 150 may determine the user through their social networking account name and/or profile, and may utilize the user's information to generate an invoice to the user that may be processed to provide a payment to the merchant for the item in the post and associated with the item tag in the post. Social commerce application 150 may generate the invoice communicated to communication device 110 and/or merchant device 120 for payment and fulfillment of the purchase. The invoice may be communicated to the user for approval of the purchase, for example, through the user's payment account and transaction processor. Social commerce application 150 may also be used track item information and update item information, for example, based on inventory, changing item price or description, or other updates to the item and/or merchant. Processing of the invoice may be performed by transaction processing application 142.

Transaction processing application 142 may correspond to one or more processes to execute modules and associated specialized hardware of transaction processor server 140 to receive and/or transmit information from communication device 110 and merchant device 120 for establishing payment accounts, as well as processing and completing of one or more financial transaction initiated using the payment accounts (e.g., invoices for items requested for purchase from a social networking platform). Transaction processing application 142 may correspond to specialized hardware and/or software to establish payment accounts, which may be utilized to send and receive payments and monetary transfers and engage in other financial transactions. A user associated with communication device 110 and/or a merchant associated with merchant device 120 may establish a payment account with transaction processing application 142 by providing personal and/or financial information to transaction processor server 140 and selecting an account login, password, and other security information. Similarly, the merchant associated with merchant device 120 may provide merchant information and financial information, as well as establish any authentication information required for the account. The payment accounts may be used to send and receive payments. The payment accounts may correspond to an online digital wallet, where transaction processor server 140 acts as the wallet provider, payment account maintainer, and transaction processor. The payment accounts may be accessed and/or used through a browser application and/or dedicated payment application executed by communication device 110.

Transaction processing application 142 may receive a purchase request of an item from an online social networking platform by polling the comments to a social networking post using social commerce application 150 and determining whether any comments include data within the comments that initiates a purchase request. For example, a comment by a user associated with communication device 110 to a post may include a purchase hashtag, identifier, or other data that indicates that the user wishes to purchase an item advertised for purchase in the post, as discussed herein. Social commerce application 150 may utilize transaction processing application 142 to generate an invoice by providing transaction processing application 142 transaction information to purchase the item. Transaction processing application 142 may generate an invoice using the transaction information (e.g., using a price, item description, item information, and merchant identifier). Transaction processing application 142 may have the invoice transmitted to communication device 110 and/or merchant device 120 for processing. Transaction processing application 142 may then initiate a payment between communication device 110 and/or merchant device 120 for a transaction for the item in the social networking post between the user and the merchant when the user authorizes the transaction in the invoice. The invoice may include transaction terms and a payment instrument identified by the user. Transaction processing application 142 may provide payment to the merchant using the payment instrument, and may provide a transaction history to communication device 110, merchant device 120, or store the history with one or more accounts. The payment may be provided to the merchant's payment account with transaction processor server 140.

In various embodiments, transaction processor server 140 includes other applications 144 as may be desired in particular embodiments to provide features to transaction processor server 134. For example, other applications 144 may include security applications for implementing server-side security features, programmatic client applications for interfacing with appropriate application programming interfaces (APIs) over network 150, or other types of applications. Other applications 144 may contain software programs, executable by a processor, including a graphical user interface (GUI), configured to provide an interface to the user when accessing transaction processor server 134. In various embodiments where not provided by transaction processing application 142, other applications 144 may include connection and/or communication applications, which may be utilized to communicate information to over network 150.

Additionally, transaction processor server 140 includes database 146. As previously discussed, the entity corresponding to communication device 110 and/or merchant device 120 may establish one or more payment accounts with transaction processor server 140. Payment accounts in database 146 may include entity information, such as name, address, birthdate, merchant information, partner information, payment/funding information, additional user financial information, and/or other desired user data. The entity may link to their respective payment accounts through an account, user, merchant, partner, and/or device identifier. Thus, when an identifier is transmitted to transaction processor server 140, e.g. from communication device 110 and/or merchant device 120, a payment account belonging to the entity may be found. Database 146 may further include information necessary to access one or more social networking accounts and/or item sales information, such as inventory management system information.

In various embodiments, transaction processor server 140 includes at least one network interface component 148 adapted to communicate communication device 110, home device 130, and/or merchant device 120 over network 150. In various embodiments, network interface component 148 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

Network 150 may be implemented as a single network or a combination of multiple networks. For example, in various embodiments, network 150 may include the Internet or one or more intranets, landline networks, wireless networks, and/or other appropriate types of networks. Thus, network 150 may correspond to small scale communication networks, such as a private or local area network, or a larger scale network, such as a wide area network or the Internet, accessible by the various components of system 100.

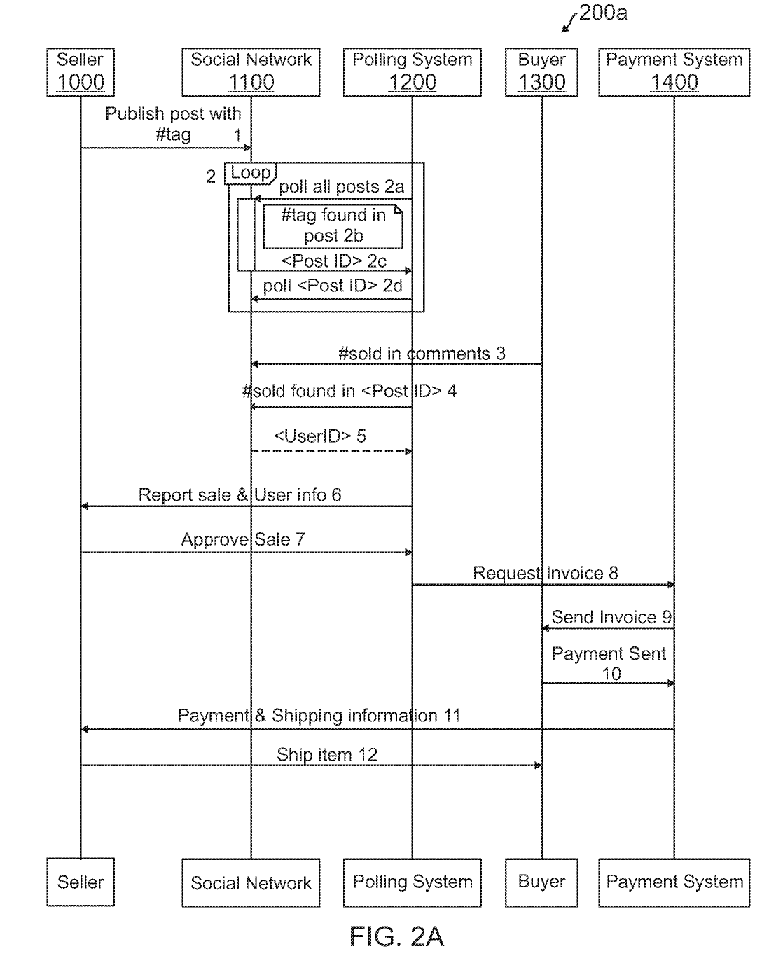

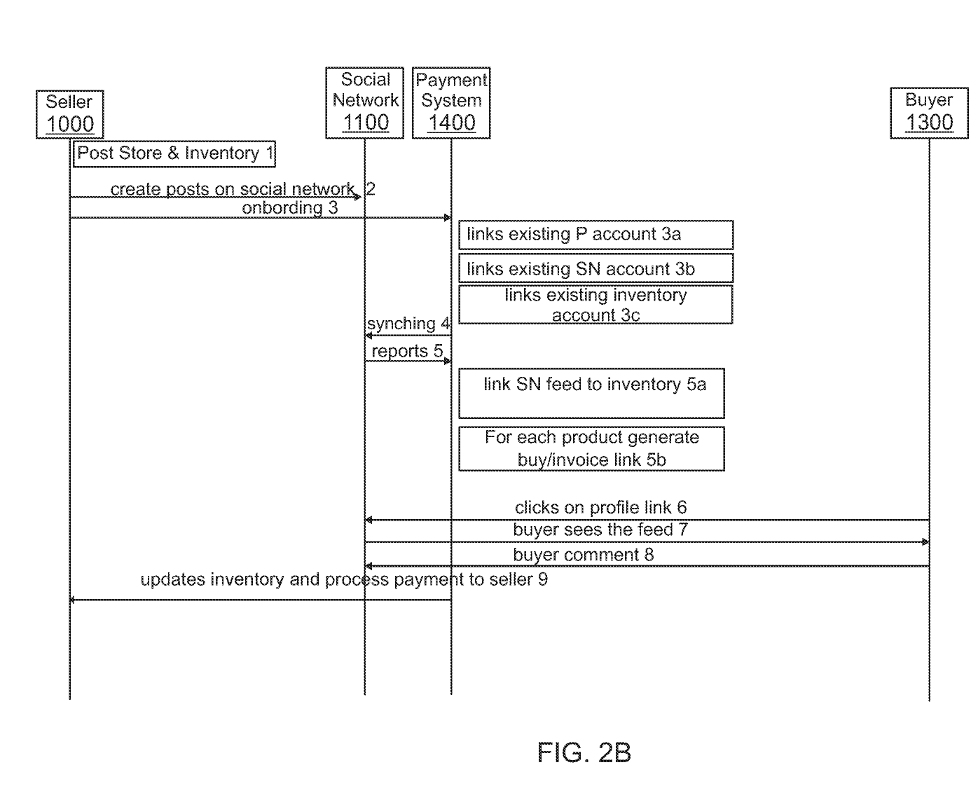

FIG. 2A is an exemplary flowchart to determine purchase requests and generate invoices for users from a social networking post by a seller, according to an embodiment. Environment 200a of FIG. 2A includes a seller 1000, a social network 1100, a polling system 1200, a buyer 1300, and a payment system 1400. Seller 1000 may correspond to a seller of goods, products or services (e.g., an item or items), which may utilize a device to sell items on social network 1100 using a transaction processing system providing polling system 1200 and payment system 1400. Buyer 1300 may purchase items on social network 1100 using the transaction processing system through polling system 1200 and payment system 1400.

For example, seller 1000 may first publish a post to social network 1100 with a hashtag (or #tag) that identifies the post as providing an item for sale at step 1. The post may include the hashtag, or may include other identifiers or identifying data that allows polling system 1200 to identify the post as selling an item from seller 1000, and may allow polling system 1200 to access an inventory management system for seller 1000 and retrieve item information for the item for sale. For example, the loop at step 2 may be performed by polling system 1200 on social network 1100 to process seller 1000's posts to social network 1100. The loop at step 2 includes substeps of polling all posts by seller 1000 at substep 2a, identifying a hashtag or other item information in a post at substep 2b, and retrieving the post ID at substep 2c. Using the post ID, at substep 2d, the polling system may then poll the post to identify if any users commenting on the post with the post ID have provided a comment including a purchase request for the item.

Buyer 1300 may provide a hashtag or other identifier or data in a comment to the post ID that corresponds to a purchase request by buyer 1300 for the item from seller 1000. At step 3, a hashtag correspond to a sell from seller 1000 to buyer 1300, for example, a purchase request hashtag or other data, may be added to in a comment to the post ID on social network 1100. Thus, polling system 1200 may locate the purchase request hashtag used to purchase the item by buyer 1300 (e.g., sell the item from seller 1000 to buyer 1300) in the comments to the post ID, at step 4. Polling system 1200 may retrieve the user's user ID at step 5 in order to generate an invoice.

In certain embodiments, at step 6, polling system 1200 may report the sale and user information to seller 1000, for example, to an inventory management system and/or merchant marketplace to determine whether stock is available for sale to buyer 1300 having the using information. Where seller 100 approves the sale at step 7, seller 1000 may provide the approval to polling system 1200. Polling system 1200 may then request that an invoice is generated using payment system 1400, at step 8, which may be generated and transmitted from payment system 1400 to buyer 1300 at step 9. Buyer 1300 may provide payment to payment system 1400 at step 10, where payment system 1400 may then resolve the transaction with seller 1000 by transmitting maybe and shipping information at step 11 to seller 1000. Seller 1000 may then ship the item to buyer 1300 at step 12.

FIG. 2B is an exemplary flowchart for providing onboarding to an integration platform for item sales through social networking posts of a seller, according to an embodiment. Environment 200b of FIG. 2B includes seller 1000, social network 1100, buyer 1300, and payment system 1400 discussed in reference to environment 200a of FIG. 2A. Thus, seller 1000 may correspond to a seller of goods, products or services (e.g., an item or items), which may utilize a device to sell items on social network 1100 after on-boarding with a transaction processing system providing payment system 1400. Buyer 1300 may purchase items on social network 1100 using the transaction processing system after seller 1000 onboards with the transaction processing system to perform social networking sales of seller 1000's inventory through social network 1100.

At step 1, seller 1000 may post their store and inventory to an online marketplace or inventory management system for access by the transaction processing system during sales of items. In other embodiments, seller 1000 may instead provide information at step 1 for the inventory or store directly to payment system 1400. Seller 1000 may then create posts on social network 1100 of items for sale at step 2, and may onboard with payment system 1400, at step 3, to provide information for the posts and/or social networking account, as well as any inventory management or marketplace information for items for sale, to payment system 1400. Payment system 1400 may perform substeps at step 3 to onboard seller 1000, including linking an existing payment account at substep 3a, linking an existing social networking account at substep 3b, and linking an existing inventory account or management system at substep 3c. Payment system 1400 may the synchronize the linked accounts and information with the posts on social network 1100 at step 4 in order to onboard seller 1000, and may receive reports of posts from social network 1100 at step 5.

The reports of posts received by payment system 1400 at step 5 may include post data to identify posts having items for sale, as well as comments that include purchase requests for the items from users commenting on the posts. For example, at substep 5a, payment system 1400 may link the social networking feed and posts to inventory for seller 1000 available with the inventory management system. For each product available in the posts, at step 5b a buy/invoice link may be generated. Thus, when buyer 1300 clicks on the profile link at step 6 for seller 1000 on social network 1100, buyer 1300 may view seller 1000's feed at step 7. Buyer 1300 may provide a comment at step 8 on social network 1100 to seller 1000's post, as discussed in reference to environment 200a of FIG. 2A, and payment system 1400 may update inventory and process a payment to seller 1000 at step 9.

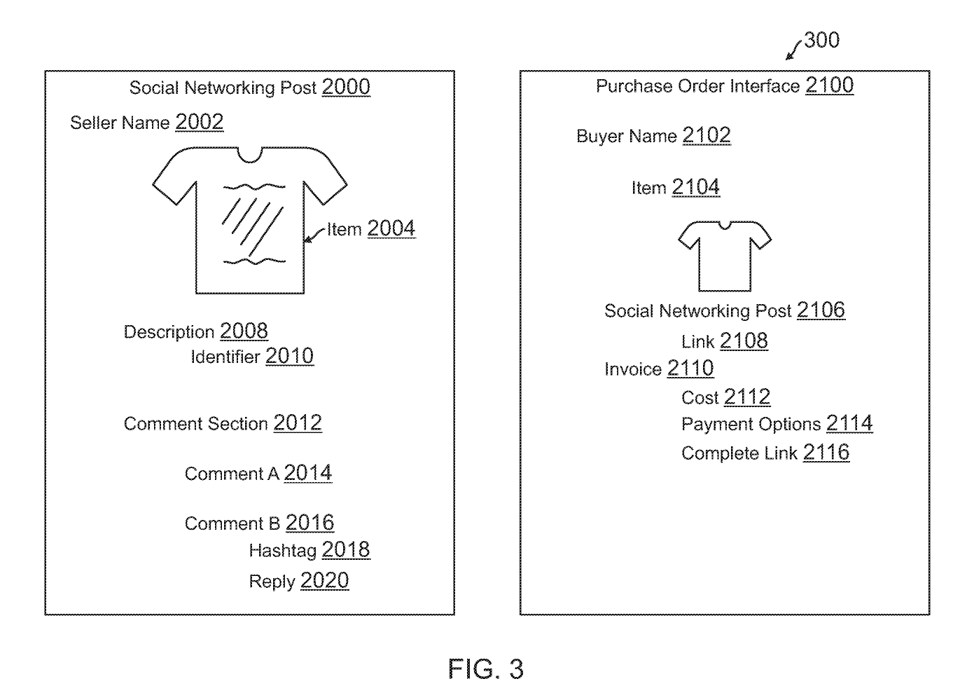

FIG. 3 is a block diagram of a social networking post used to generate an invoice to a user purchasing an item in the social networking post, according to an embodiment. Social networking post 2000 may be posted by a merchant device and/or viewed by a communication device, such as merchant device 120 and/or communication device 110, respectively, in system 100 of FIG. 1. Similarly, purchase order interface 2100 may be provided by a transaction processor server and/or merchant device, and viewed by a communication device, such as transaction processor server 140, merchant device 120 and/or communication device 110, respectively, in system 100 of FIG. 1.

Social networking post 2000 may be posted by a merchant in a seller name 2002 to a social networking platform, such as a media sharing (e.g., image/video posting) platform, a microblogging platform, or another platform allowing social interactions between users. A user, such as a consumer, may utilize a device to access social networking post 2000 and view the merchant's name in seller name 2002, for example, by entering the merchant's name, handle, description, or other identifier or identifying information including through scanning of a merchant QR or bar code using the device and automatically accessing the merchant's social networking account. The user may then view an item 2004 for sale by seller name 2002. Item 2004 may be posted by the merchant and linked to inventory data of item 2004 for available inventory. Item 2004 may further include a description 2008 for item 2004, which may include an identifier 2010 used by a transaction processor to link item 2004 to the inventory of the item and allow the transaction processor to identify the item and associated item sale information (e.g., cost, tax, shipping, inventory, etc.) to generate invoices for users that wish to purchase the item.

The user may the use comment section 2012 to request a purchase of the item through the transaction processor if the user wishes to purchase the item. In this regard, comment section 2012 may include a comment A 2014 and a comment B 2016. Comment A 2012 may correspond to a generic comment, such as a reply to social networking post 2000 by a user or a response to social networking post 2000. The user that wishes to purchase item 2004 may provide a comment B 2016 with proper information, text, or other response that corresponds to a purchase requests and causes the transaction process to identify comment B 2016 as a purchase request by the commenting user to purchase item 2004. For example, comment B 2016 may include a hashtag 2018. In response, the transaction processor and/or merchant may provide a reply 2020, such as acknowledgement of the purchase request, transmission of the invoice for item 2004, completion of a purchase for item 2004 by the commenting user, and/or lack of inventory or other issue with fulfilling an order for item 2004.

If the transaction processor generates an invoice for item 2004, the transaction processor may provide a link, message, or other electronic communication to the commenting user requesting the purchase request for item 2004 that causes purchase order interface 2100 to be presenting to the user. Purchase order interface 2100 includes a buyer name 2102 for the buyer purchasing item 2004, which may correspond to a name, handle, or other identifier for the user and/or the user's social networking account that commented to item 2004 in order to purchase item 2004. Purchase order interface 2100 may further include item information for item 2004 and/or social networking information for social networking post 2000, including an item 2104 description, such as a summary of social networking post 2100 in social networking post summary 2106 and/or a link 2108 to social networking post 2000. Moreover, purchase order interface 2100 may further include an invoice 2110 to purchase item 2004, which may include a cost 2112, payment options 2114, and/or a completion link 2116 to effectuate payment and purchase of item 2004.

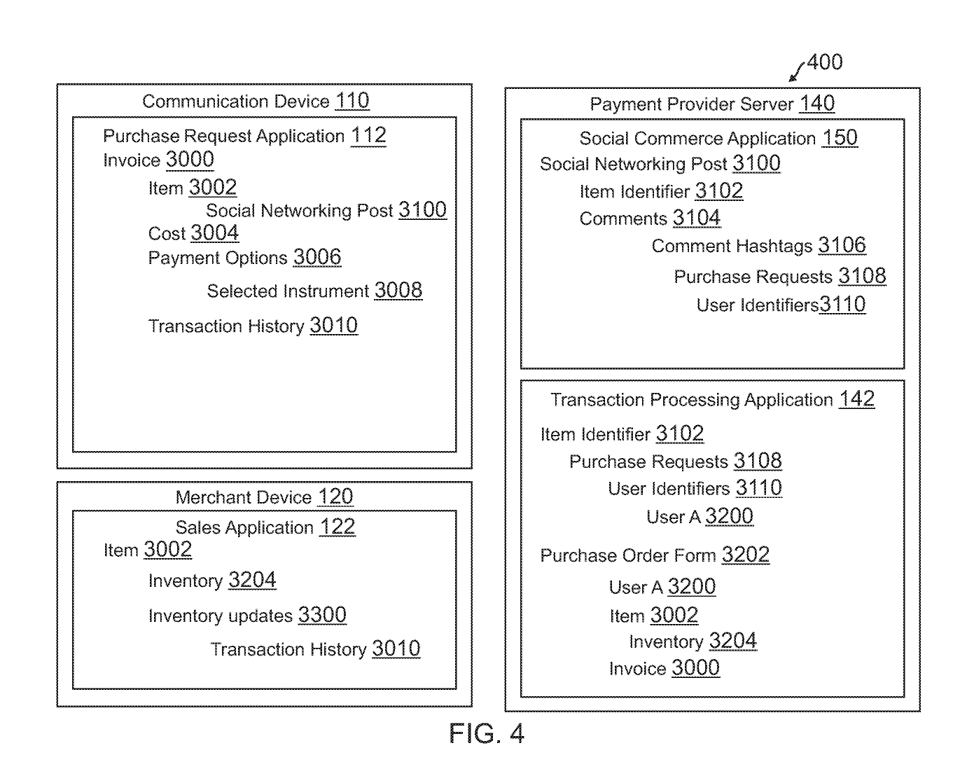

FIG. 4 is a block diagram of a transaction processor server interacting with a communication device and a merchant device to provide sales and transaction processing through social networking posts, according to an embodiment. Environment 400 of FIG. 4 includes a communication device 110, a merchant device 120, and a transaction processor server 140 all discussed in reference to system 100 of FIG. 1.

Payment provider server 140 includes a social commerce application 150 and a transaction processing application 142 having the same features and processes as discussed in reference to system 100 of FIG. 1. In this regard, social commerce application 150 may be utilized to process one or more social networking posts to determine whether a social networking post advertises an item for sale, and if so, whether any comments by users request purchase of the item for sale. For example, social commerce application 150 accesses a social networking post 3100. Social networking post 3100 includes an item identifier 3102 in order to identify the item for sale in social networking post 3100. Social networking post 3100 further includes comments 3104 to the item for sale in social networking post 3100, which may have comment hashtags 3106. Where on or more of comment hashtags includes purchase requests 3108 based on the data in comments 3104 (e.g., the comment hashtags 3106 requesting purchase of the item), user identifiers 3110 may be retrieved for comment hashtags 3106 having purchase requests 3108 for processing by transaction processing application 142.

Payment provider server 140 includes a transaction processing application 142 that may be utilized to generate one or more invoices for purchase requests 3108 using user identifiers 3110. Item identifier 3102 from social networking post 3100 may be associated with purchase requests 3108 for user identifiers 3110 that requests purchase of the item associated with item identifier 3102 in social networking post 3100. For example, user A 3200 identifier in item identifiers 3110 may be requesting purchase of the item associated with item identifier 3102 from the merchant associated with merchant device 120. Transaction processing application 142 may utilize item identifier 3102 to retrieve relevant item information from an inventory management system, and may generate an invoice 3000 in purchase order form 3202 for user A 3200 to purchase an item 3002. Purchase order form 3202 includes user A 3200 identifier, item 3002 for inventory 3204, and invoice 3000 that may be transmitted to communication device 110.

Communication device 110 includes a purchase request application 112 having the same features and processes as discussed in reference to system 100 of FIG. 1. In this regard, purchase request application 112 may be used to request purchase of item 3002, for example, by entering one or purchase requests 3108 in comments 3104. Purchase request application 112 may further be used to process invoice 3000 for item 3002 in social networking post 3100. Invoice 3000 may include cost 3004, which may be paid with payment options 3006, for example, using selected instrument 3008. Additionally, purchase request application 112 may receive a transaction history 3010 for invoice 3000.

Merchant device 120 includes a sales application 122 having the same features and processes as discussed in reference to system 100 of FIG. 1. In this regard, sales application 122 may be used to assist in invoice generation for item 3002, as well as complete purchase of item 3002. For example, sales application 122 may be associated with an inventory management system that may provide inventory 3204 for item 3002. Sales application 122 may further receive inventory updates 3300, such as purchases of item 3002 that may be found in transaction history 3010.

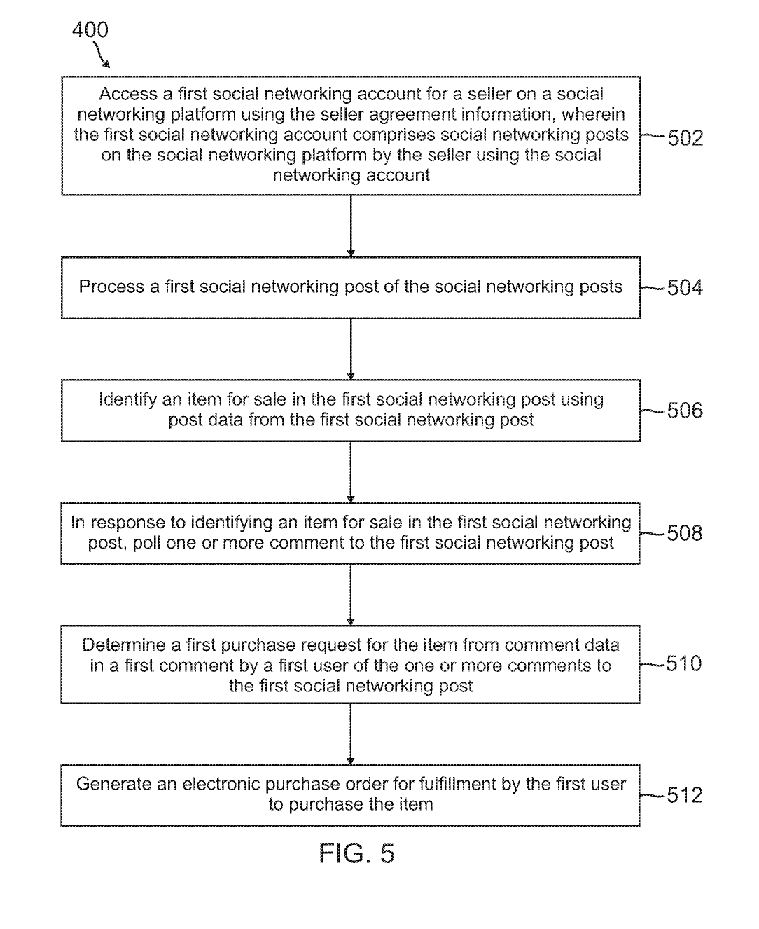

FIG. 5 is an exemplary process flowchart for social commerce payments based on comments to social networking posts, according to an embodiment. Note that one or more steps, processes, and methods described herein may be omitted, performed in a different sequence, or combined as desired or appropriate.

At step 502, a first social networking account for a seller on a social networking platform is accessed using seller agreement information for a seller, wherein the first social networking account comprises social networking posts on the social networking platform by the seller using the social networking account. In order to onboard the seller and receive the seller agreement information, an onboarding request may be received from the seller for the service provider system, wherein the onboarding requests authorizes the seller for sales through the social networking posts of the seller on the social networking platform. Additionally, the seller agreement information may be received from the seller, wherein the seller agreement information comprises account information for the first social networking account and a billing agreement between the seller and an administrative entity for the service provider system. In response, the first social networking account may be authorized for sales through the social networking posts, wherein the service provider system periodically polls the social networking posts in response to receiving the seller agreement information. The seller agreement information may further comprise access information for an inventory management system of the seller, and wherein the inventory management system comprises item information for items sold by the seller using the social networking posts.

At step 504, a first social networking post of the social networking posts is processed. Thus, an item for sale in the first social networking post is identified using post data from the first social networking post, at step 506. The post data for the first social networking post may comprise at least one of an alphanumeric item tag or an item description, and wherein the item is identified using the at least one of the alphanumeric item tag or the item description.

In response to identifying an item for sale in the first social networking post, at step 508, one or more comment to the first social networking post is polled. A first purchase request for the item may be determined from comment data in a first comment by a first user of the one or more comments to the first social networking post, at step 510. The comment data may comprise at least one hashtag identifier by the first user that requests purchase of the item, wherein the first purchase request is determined based on the at least one hashtag identifier. In certain embodiments, the at least one hashtag identifier comprises a plurality of hashtag identifiers, wherein the plurality of hashtag identifiers request at least one variation of the item, and wherein the at least one variation comprises size, color, shape, model, quantity, or gender specification.

In order to onboard the buyer to perform social networking purchasing, prior to the first user providing the purchase request in the comment data of the first user, an onboarding request may be received from the first user for the service provider system, wherein the onboarding requests authorizes the first user to perform purchasing through user comments on the social networking platform. Further an account identifier for the second social networking account and a contact address for at least the electronic purchase order may be received, and the second social networking account of the first user may be authorized for purchases through the user comments on the social networking platform, wherein at least the electronic purchase order is communicated to the first user through the contact address in the user account information.

At step 512, an electronic purchase order for fulfillment by the first user to purchase the item may be generated. In order to generate the electronic purchase order, the inventory management system of the seller may be accessed using the seller agreement information, and at least an inventory of the item for sale in the first social networking post may be determined using the inventory management system, wherein the electronic purchase order is generated in response to the inventory of the item. The inventory may further comprise at least one variation of the item so that variation requests for the item by the first user may be determined using the first comment and it may be determined whether the inventory satisfies the variation requests based on the at least one variation of the item in the stock of the item, wherein the electronic purchase order is further generated based on the determining whether the inventory satisfies the variation requests. Thus, the first social networking post may comprise a first variation of the item, wherein a second social networking post by the seller comprises a second variation of the item, and wherein the variation request is further determined based on the first social networking post and the second social networking post, for example, which item the first user provides a comment to.

Additionally, the electronic purchase order may be communicated to the first user. After communication to the user, there may be received, from the first user, authorization to purchase the item from the electronic purchase order, wherein the authorization further comprising payment information and shipping information for the first user. A payment for the item may be processed using the payment information, and a transaction history may be communicated to the seller, wherein the transaction history comprises at least the shipping information. Further, in response to processing a purchase of the item, the inventory of the item may be updated with the inventory management system. A second comment from a second user may also be processed, wherein the second comment corresponds to a second purchase request of the item by the second user. Thus, availability of the item may be determined based on the electronic purchase order and an inventory of the item with the seller, and the seller may be updated with the availability of the item.

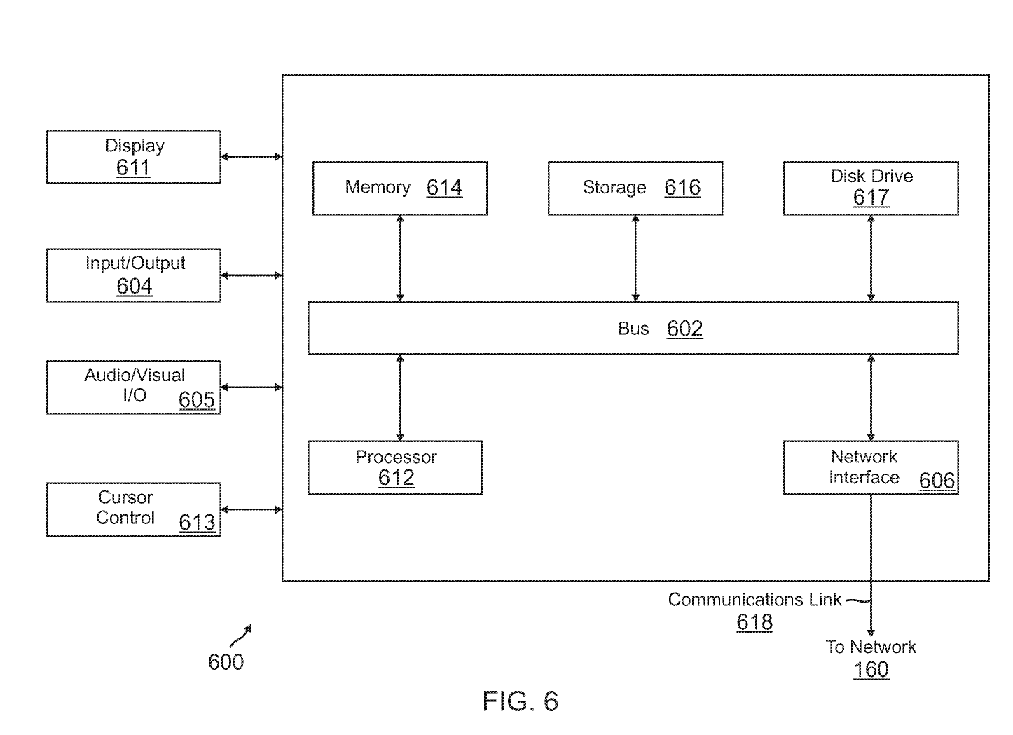

FIG. 6 is a block diagram of a computer system suitable for implementing one or more components in FIG. 1, according to an embodiment. In various embodiments, the communication device may comprise a personal computing device (e.g., smart phone, a computing tablet, a personal computer, laptop, a wearable computing device such as glasses or a watch, Bluetooth device, key FOB, badge, etc.) capable of communicating with the network. The service provider may utilize a network computing device (e.g., a network server) capable of communicating with the network. It should be appreciated that each of the devices utilized by users and service providers may be implemented as computer system 600 in a manner as follows.

Computer system 600 includes a bus 602 or other communication mechanism for communicating information data, signals, and information between various components of computer system 600. Components include an input/output (I/O) component 604 that processes a user action, such as selecting keys from a keypad/keyboard, selecting one or more buttons, image, or links, and/or moving one or more images, etc., and sends a corresponding signal to bus 602. I/O component 604 may also include an output component, such as a display 611 and a cursor control 613 (such as a keyboard, keypad, mouse, etc.). An optional audio input/output component 605 may also be included to allow a user to use voice for inputting information by converting audio signals. Audio I/O component 605 may allow the user to hear audio. A transceiver or network interface 606 transmits and receives signals between computer system 600 and other devices, such as another communication device, service device, or a service provider server via network 150. In various embodiments, the transmission is wireless, although other transmission mediums and methods may also be suitable. One or more processors 612, which can be a micro-controller, digital signal processor (DSP), or other processing component, processes these various signals, such as for display on computer system 600 or transmission to other devices via a communication link 618. Processor(s) 612 may also control transmission of information, such as cookies or IP addresses, to other devices.

Components of computer system 600 also include a system memory component 614 (e.g., RAM), a static storage component 616 (e.g., ROM), and/or a disk drive 617. Computer system 600 performs specific operations by processor(s) 612 and other components by executing one or more sequences of instructions contained in system memory component 614. Logic may be encoded in a computer readable medium, which may refer to any medium that participates in providing instructions to processor(s) 612 for execution. Such a medium may take many forms, including but not limited to, non-volatile media, volatile media, and transmission media. In various embodiments, non-volatile media includes optical or magnetic disks, volatile media includes dynamic memory, such as system memory component 614, and transmission media includes coaxial cables, copper wire, and fiber optics, including wires that comprise bus 602. In various embodiments, the logic is encoded in non-transitory computer readable medium. In one example, transmission media may take the form of acoustic or light waves, such as those generated during radio wave, optical, and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EEPROM, FLASH-EEPROM, any other memory chip or cartridge, or any other medium from which a computer is adapted to read.

In various embodiments of the present disclosure, execution of instruction sequences to practice the present disclosure may be performed by computer system 600. In various other embodiments of the present disclosure, a plurality of computer systems 600 coupled by communication link 618 to the network (e.g., such as a LAN, WLAN, PTSN, and/or various other wired or wireless networks, including telecommunications, mobile, and cellular phone networks) may perform instruction sequences to practice the present disclosure in coordination with one another.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A service provider system, comprising:
a non-transitory memory storing seller agreement information for a seller; and
one or more hardware processors configured to execute instructions to cause the service provider system to perform operations comprising:
accessing a first social networking account for a seller on a social networking platform using the seller agreement information, wherein the first social networking account comprises social networking posts on the social networking platform by the seller using the social networking account;
processing a first social networking post of the social networking posts;
identifying an item for sale in the first social networking post using data from the first social networking post;
in response to identifying an item for sale in the first social networking post, determining a comment to the first social networking post;
determining a first purchase request for the item from the comment;
generating an electronic purchase order for fulfillment by the first user to purchase the item; and
communicating the electronic purchase order to the first user.

2. The service provider system of claim 1, wherein the operations further comprise:
receiving, from the first user, authorization to purchase the item from the electronic purchase order, wherein the authorization comprises payment information and shipping information for the first user;
processing a payment for the item using the payment information; and
communicating a transaction history to the seller, wherein the transaction history comprises at least the shipping information.

3. The service provider system of claim 1, wherein prior to determining the first purchase request, the operations further comprise:
receiving an onboarding request from the first user for the service provider system, wherein the onboarding requests authorizes the first user to perform purchasing through user comments on the social networking platform;
receiving an account identifier for the second social networking account and a contact address for at least the electronic purchase order; and
authorizing the second social networking account of the first user for purchases through the user comments on the social networking platform, wherein at least the electronic purchase order is communicated to the first user through the contact address in the user account information.

4. The service provider system of claim 1, wherein prior to the accessing the first social networking account of the seller, the operations further comprise:
receiving an onboarding request from the seller for the service provider system, wherein the onboarding requests authorizes the seller for sales through the social networking posts of the seller on the social networking platform;
receiving the seller agreement information from the seller, wherein the seller agreement information comprises account information for the first social networking account and a billing agreement between the seller and an administrative entity for the service provider system; and
authorizing the first social networking account for sales through the social networking posts, wherein the service provider system periodically polls the social networking posts in response to receiving the seller agreement information.

5. The service provider system of claim 4, wherein the seller agreement information further comprise access information for an inventory management system of the seller, and wherein the inventory management system comprises item information for items sold by the seller using the social networking posts.

6. The service provider system of claim 5, wherein prior to the generating the electronic purchase order, the operations further comprise:
accessing the inventory management system of the seller using the seller agreement information; and
determining at least an inventory of the item for sale in the first social networking post, wherein the electronic purchase order is generated in response to the inventory of the item.

7. The service provider system of claim 6, wherein the inventory further comprises at least one variation of the item, and wherein the operations further comprise:
determining variation requests for the item by the first user using the first comment; and
determining whether the inventory satisfies the variation requests based on the at least one variation of the item in the stock of the item, wherein the electronic purchase order is further generated based on the determining whether the inventory satisfies the variation requests.

8. The service provider system of claim 6, wherein the first social networking post comprises a first variation of the item, wherein a second social networking post by the seller comprises a second variation of the item, and wherein the variation request is further determined based on the first social networking post and the second social networking post.

9. The service provider system of claim 6, wherein the operations further comprise:
in response to processing a purchase of the item, updating the inventory of the item with the inventory management system.

10. The service provider system of claim 1, wherein the post data for the first social networking post comprises at least one of an alphanumeric item tag or an item description, and wherein the item is identified using the at least one of the alphanumeric item tag or the item description.

11. The service provider system of claim 1, wherein the comment data comprises at least one hashtag identifier by the first user that requests purchase of the item, and wherein the first purchase request is determined based on the at least one hashtag identifier.

12. The service provider system of claim 11, wherein the at least one hashtag identifier comprises a plurality of hashtag identifiers, wherein the plurality of hashtag identifiers request at least one variation of the item, and wherein the at least one variation comprises size, color, shape, model, quantity, or gender specification.

13. The service provider system of claim 1, wherein the operations further comprise:
processing a second comment from a second user, wherein the second comment corresponds to a second purchase request of the item by the second user;
determining availability of the item based on the electronic purchase order and an inventory of the item; and
updating the seller with the availability of the item.

14. A method comprising:
receiving social networking posts on a social networking platform by a seller;
identifying an item for sale in one of the social networking posts using post data from the one of the social networking posts;
retrieving comments to the one of the social networking posts;
parsing the comments for one or more identifiers requesting purchase of the item in the one of the social networking posts;
in response to parsing the comments, determining a purchase request for the item from a user in one of the comments;
generating a purchase form for purchase of the item by the user; and
communicating the purchase form to the user.

15. The method of claim 14, further comprising:
accessing an inventory management system of the seller, wherein the inventory management system comprises inventory information for the item, and wherein the purchase form is generated based on the inventory information.

16. The method of claim 15, further comprising:
in response to processing a purchase of the item, updating the inventory information of the item with the inventory management system.

17. The method of claim 14, wherein the post data for the one of the social networking posts comprises at least one of an alphanumeric item tag or an item description, and wherein the item is identified using the at least one of the alphanumeric item tag or the item description.

18. The method of claim 14, wherein the one or more identifiers comprises one or more hashtag identifiers by the user that requests purchase of the item, and wherein the purchase form is generated in response to the one or more hashtag identifiers.

19. The method of claim 18, wherein the one or more hashtag identifiers comprises a plurality of hashtag identifiers, wherein the plurality of hashtag identifiers request at least one variation of the item, and wherein the at least one variation comprises size, color, shape, model, quantity, or gender specification.

20. A non-transitory machine-readable medium having stored thereon machine-readable instructions executable to cause a machine to perform operations comprising:
accessing a first social networking account for a seller on a social networking platform using the seller agreement information, wherein the first social networking account comprises social networking posts on the social networking platform by the seller using the social networking account;
processing a first social networking post;
identifying an item for sale in the first social networking post using data from the first social networking post;
in response to identifying an item for sale in the first social networking post, determining a comment to the first social networking post by a first user;
determining a first purchase request for the item from the comment;
generating an electronic purchase order for fulfillment by the first user to purchase the item; and
communicating the electronic purchase order to the first user.
